(19) United States
(12) Patent Application Publication
(10) Pub. No.: US 2014/0354541 A1
(43) Pub. Date: Dec. 4, 2014

(54) WEBPAGE BROWSING METHOD AND APPARATUS BASED ON PHYSICAL MOTION

(71) Applicant: Fajing Li, Shenzhen (CN)

(72) Inventor: Fajing Li, Shenzhen (CN)

(73) Assignee: TENCENT TECHNOLOGY (SHENZHEN) COMPANY LIMITED, Shenzhen, Guangdong (CN)

(21) Appl. No.: 14/354,123

(22) PCT Filed: Jul. 30, 2012
(86) PCT No.: PCT/CN2012/079334

§ 371 Date: Aug. 21, 2014

(30) Foreign Application Priority Data
Oct. 26, 2011 (CN) 201110329229.6

(51) Int. Cl. G06F 3/01; G06F 17/30

(52) U.S. Cl. CPC G06F 3/011; G06F 17/30905
USPC 345/156

(57) ABSTRACT

The present disclosure, pertaining to the field of computer technologies, discloses a webpage browsing method and apparatus based on physical motion. The method includes: acquiring spatial location information of a mobile terminal in a relatively stationary state; upon detecting a motion change of the mobile terminal, acquiring spatial location information and motion information of the mobile terminal experiencing the motion change; if motion information of the mobile terminal is greater than a predetermined threshold, comparing the spatial location information of the mobile terminal in the relatively stationary state with the spatial location information of the mobile terminal experiencing the motion change to acquire a spatial location offset after the motion change; and performing a corresponding browse operation on a webpage on the mobile terminal according to a mapping relationship between the spatial location offset and a webpage operation.

This application claims priority to Chinese Patent Application No. 201110329229.6, filed before Chinese Patent Office on Oct. 26, 2011 and entitled “WEBPAGE BROWSING METHOD AND APPARATUS BASED ON PHYSICAL MOTION”, which is incorporated herein by reference in its entirety.

### TECHNICAL FIELD

The present disclosure relates to the field of computer technologies, and in particular, to a webpage browsing method and an apparatus based on physical motion.

### BACKGROUND

With the development of wireless Internet technologies and smart terminals, more and more people start to use mobile terminals to access the Internet and access webpages through browsers carried by the mobile terminals.

In the existing field of browser application software for mobile terminals, webpage browsing is on a basis of navigation keys of the mobile terminals. A cursor moving among selectable contents on a webpage and moving operations between a previous webpage and a next webpage may be achieved by controlling four directional navigation keys, namely, up, down, left, and right, and other functional keys are required to perform corresponding forward and backward page turnover operations during browsing.

The prior webpage browse operations by using mobile terminals completely rely on physical keys on the mobile terminals, that is, navigation keys and/or functional keys. When there are excessive contents on a webpage, a user needs to frequently press keys to complete browse operations, where frequent operations are easy to cause a user misoperation, and frequently using a physical key accelerates service life shortening of the physical key.

### SUMMARY

To make webpage browse operations by using a mobile terminal become more flexible and be independent from navigation keys of the mobile terminal, embodiments of the present disclosure provide a webpage browsing method and apparatus based on physical motion. The technical solutions are as follows:

An embodiment of the present disclosure provides a webpage browsing method based on physical motion, including:

acquiring spatial location information of a mobile terminal in a relatively stationary state;

upon detecting a motion change of the mobile terminal, acquiring spatial location information and motion information of the mobile terminal experiencing the motion change;

if motion information of the mobile terminal is greater than a predetermined threshold, comparing the spatial location information of the mobile terminal in the relatively stationary state with the spatial location information of the mobile terminal experiencing the motion change to acquire a spatial location offset after the motion change; and

performing a corresponding browse operation on a webpage on the mobile terminal according to a mapping relationship between the spatial location offset and a webpage operation.

An embodiment of the present disclosure provides a webpage browsing apparatus based on physical motion, including:

a first acquiring module, configured to acquire spatial location information of a mobile terminal in a relatively stationary state;

a second acquiring module, configured to: upon detecting a motion change of the mobile terminal, acquire spatial location information and motion information of the mobile terminal experiencing the motion change;

a comparing module, configured to: if motion information of the mobile terminal is greater than a predetermined threshold, compare the spatial location information of the mobile terminal in the relatively stationary state with the spatial location information of the mobile terminal experiencing the motion change to acquire a spatial location offset after the motion change; and

a processing module, configured to perform a corresponding browse operation on a webpage on the mobile terminal according to a mapping relationship between the spatial location offset and a webpage operation.

According to the technical solutions of the present disclosure, spatial location information of a mobile terminal experiencing a motion change is compared with the spatial location information of the mobile terminal in a relatively stationary state to acquire a spatial location offset after the motion change and perform a corresponding browse operation on a webpage on the mobile terminal according to a mapping relationship between the spatial location offset and a webpage operation. By getting rid of relying on physical keys for webpage browsing on a mobile terminal, occurrence of misoperations is reduced, and user experience is improved.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art may derive other accompanying drawings based on these accompanying drawings without any creative efforts.

FIG. 1 is a schematic flowchart of a method for browsing a webpage based on physical motion according to an embodiment of the present disclosure;

FIG. 2 is a schematic flowchart of a method for browsing a webpage based on physical motion according to an embodiment of the present disclosure; and

FIG. 3 is a schematic structural diagram of an apparatus for browsing a webpage based on physical motion according to an embodiment of the present disclosure.

### DETAILED DESCRIPTION

To make the technical solutions and advantages of the present disclosure clearer, the embodiments of the present disclosure are described in detail below with reference to the accompanying drawings.

### Embodiment 1

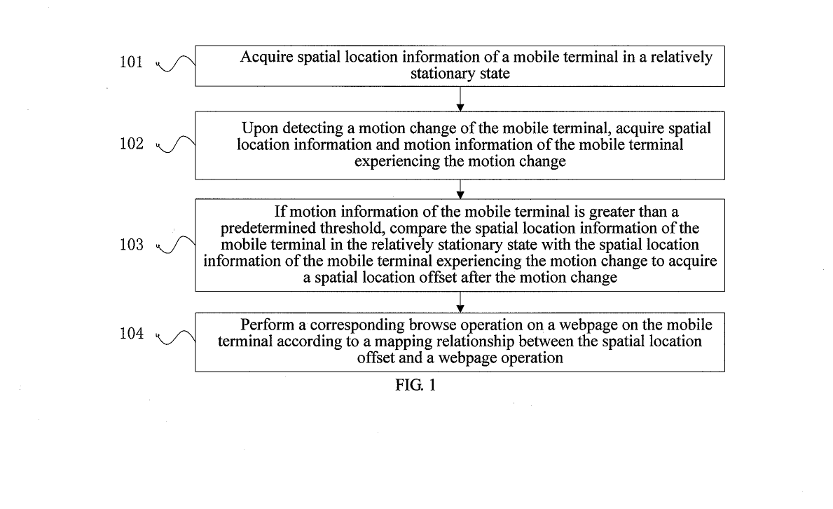

An embodiment of the present disclosure provides a webpage browsing method based on physical motion. The method, whose flowchart is as illustrated in FIG. 1, includes the following steps:

step 101: acquiring spatial location information of a mobile terminal in a relatively stationary state;

step 102: upon detecting a motion change of the mobile terminal, acquiring spatial location information and motion information of the mobile terminal experiencing the motion change;

step 103: if motion information of the mobile terminal is greater than a predetermined threshold, comparing the spatial location information of the mobile terminal in the relatively stationary state with the spatial location information of the mobile terminal experiencing the motion change to acquire a spatial location offset after the motion change; and

step 104: performing a corresponding browse operation on a webpage on the mobile terminal according to a mapping relationship between the spatial location offset and a webpage operation.

In the embodiments of the present disclosure, spatial location information of a mobile terminal experiencing a motion change and the spatial location information of the mobile terminal in a relatively stationary state acquired by a sensor are compared to acquire a spatial location offset after the motion change, and a corresponding browse operation is performed on a webpage on the mobile terminal according to a mapping relationship between the spatial location offset and a webpage operation. By getting rid of relying on physical keys for webpage browsing on a mobile terminal, occurrence of misoperations is reduced, and user experience is improved.

### Embodiment 2

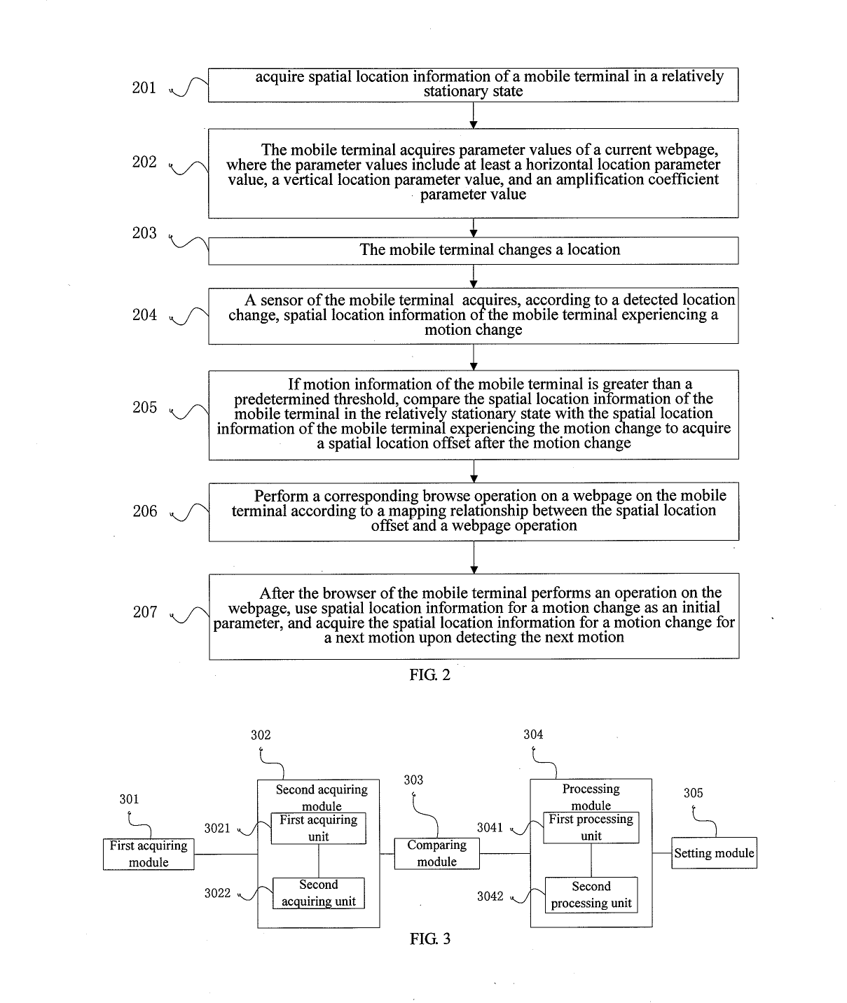

An embodiment of the present disclosure provides a webpage browsing method based on physical motion. The method, whose flowchart is as illustrated in FIG. 2, includes the following steps:

Step 201: acquiring spatial location information of a mobile terminal in a relatively stationary state.

Upon opening of a browser on a mobile terminal, various types of parameter information of the mobile terminal in a current initial state are acquired, which are used as principles for comparing with those after motion. The current location is considered as an initial location, and is in a relatively stationary state, for example, the mobile terminal may be stationarily placed on a table, or a user holds the mobile terminal and moves at a constant speed, and a relatively stationary state may further be understood as that the mobile terminal is not moved or turned over with a large range of motion, and is an relative comparison of time and the mobile terminal itself at a time interval. By using various sensors, spatial location information of the mobile terminal in a relatively stationary state is acquired. The spatial location information may be: spatial location coordinates; or spatial angular coordinates; or spatial location coordinates and spatial angular coordinates. Specific contents of the spatial location information when the mobile terminal is in a relatively stationary state include: spatial location coordinates in the relatively stationary state and spatial angular coordinates in the relatively stationary state. The mobile terminal is located in a three-dimensional space, therefore a coordinates system of a sensor adopts a spatial rectangular coordinates system, that is, three coordinates axes X, Y, and Z are used to present a space, where three axial directions are established in the coordinates system originated with the mobile terminal and in which each two axial directions are mutually perpendicular to each other, where the transverse direction of the mobile terminal is the direction of axis X, the longitudinal direction of the mobile terminal is the direction of axis Y, and the vertical direction of a plane where the mobile terminal locates is the direction of axis Z. Directions of axes in the spatial rectangular coordinates system of the mobile terminal are set by default and are not changed when the mobile terminal is placed horizontally or vertically. A sensor acquires the spatial location coordinates when the mobile terminal is in a relatively stationary state in a form of (X, Y, Z) and the spatial angular coordinates in the relatively stationary state in a form of (Qx, Qy, Qz) and sends both coordinates to a browser. The spatial rectangular coordinates record a specific location of the mobile terminal in the three-dimensional space, and are specifically used for determining a motion change of the mobile terminal; the spatial angular coordinates record a specific angle of the mobile terminal in each direction in the three-dimensional space and indicate an angle relatively generated by comparing an attitude of the mobile terminal with each axis in the spatial rectangular coordinates system in which axes are mutually perpendicular to each other, and are specifically used for determining a turnover change of the mobile terminal.

In the embodiments of the present disclosure, the mobile terminal is provided with all kinds of state parameters used for sensor detections and changed parameters due to physical motion, preferably, acquiring the spatial location information of the mobile terminal in the relatively stationary state according to a parameter acquired by at least one of a gravity sensor, an acceleration sensor, an orientation sensor, a speed sensor, an angular speed sensor, and an angular acceleration sensor, and a spatial rectangular coordinates system built in the sensor. Preferably, a detection function of a sensor may be enabled or disabled through a mobile terminal.

Further, for the initial state, primarily determine whether the initial state is obtained in a stationary state. Predetermine oscillation scopes ΔX, ΔY, ΔZ and ΔQx, ΔQy, ΔQz. Within the predetermined time range ΔT, if a difference between six parameters X1, Y2, Z3 and Qx1, Qy2, Qz3 acquired by the sensor and initially obtained parameters X, Y, Z and Qx, Qy, Qz calculated by the mobile terminal falls in the predetermined oscillation scopes ΔX, ΔY, ΔZ and ΔQx, ΔQy, ΔQz, the current state is determined as a relatively stationary state, and the initially obtained spatial location coordinates (X, Y, Z) and spatial angular coordinates (Qx, Qy, Qz) are used as the spatial location coordinates in the relatively stationary state and spatial angular coordinates in the relatively stationary state.

Since the current state is a relatively stationary state, initial motion information may be further set. The motion information may be acceleration and speed; or, angular acceleration and angular speed; or, acceleration, speed, angular acceleration, and angular speed. Specifically, for speed parameters (Vx, Vy, Vz), parameter values for each axis are 0, and for initial acceleration parameters (Ax, Ay, Az), initial angular speed parameters (Jx, Jy, Jz), and for initial angular acceleration parameters (JAx, JAy, JAz), parameter values for each axis are 0.

Step 202: acquiring, by the mobile terminal, parameter values of a current webpage, where the parameter values include at least a horizontal location parameter value, a vertical location parameter value, and an amplification coefficient parameter value.

After a browser loads a webpage and is in a relatively stationary state, acquiring the state of the current webpage, including location parameter value A for horizontal rolling, location parameter value B for vertical rolling, and current amplification coefficient parameter value a of the current webpage. The location parameter value A for horizontal rolling and location parameter value B for vertical rolling indicate a relative location rather than a certain point on a specific webpage, and are used to perform a related change operation on a horizontal location A or a vertical location B on the webpage according to a received spatial location offset to acquire a webpage moving or rolling change when the current webpage is moved or rolled.

A browser supports a multi-webpage co-existence browsing mode, that is, multi-label browsing mode, and therefore, a webpage corresponding to each label records each parameter value on the respective webpage.

Step 203: changing a location of the mobile terminal.

When a user browses a webpage through the mobile terminal, the user moves, rolls, forward and backward switches, and switches in s multi-label mode, and zooms in or zooms out a webpage according to browse intentions through all kinds of physical motion. Various types of physical motion may be: holding the mobile terminal to move upwards, downwards, to the left, and to the right, acceleratedly move upwards, downwards, to the left, and to the right, turn over upwards, downwards, to the left, and to the right, and move forwards and backwards.

It should be noted that browsing a webpage by using a mobile terminal browser is only a preferable embodiment of the present disclosure. Related operations performed according to a physical location change of the mobile terminal, that may be various kinds of operations once requiring a navigation key to change a browse location upwards, downwards, to the left, and to the right and/or turn over a webpage forward and backward within the mobile terminal, all belong to a protection scope of the present disclosure.

Step 204: acquiring, by a sensor of the mobile terminal, according to a detected location change, spatial location information of the mobile terminal experiencing a motion change.

After the location of the mobile terminal is changed through physical motion, the sensor acquires, according to the motion change, the current spatial location coordinates and spatial angular coordinates of the mobile terminal and sends the spatial location coordinates and spatial angular coordinates to the browser. At this time, there are two modes for acquiring the current spatial location coordinates and spatial angular coordinates.

(1) Upon detection of a motion change of the mobile terminal, spatial location information of the mobile terminal experiencing the motion change is acquired at each predetermined time interval.

Predetermining a time interval, such that the current spatial location coordinates and spatial angular coordinates are sent to the browser as long as the predetermined time interval is reached. For example, the predetermined time interval is 0.1 s, that is, the sensor sends, according to a motion change, the acquired current spatial location coordinates and spatial angular coordinates to the sensor every 0.1 s, and the browser uses the received spatial location coordinates and spatial angular coordinates acquired at the first predetermined time as the spatial location coordinates (X2, Y2, Z2) for a motion change and the spatial angular coordinates (Qx2, Qy2, Qz2) for a motion change after the location change. If the motion is location moving, the speed sensor and acceleration sensor respectively acquire a real-time speed and a real-time acceleration speed of the mobile terminal corresponding to motion in each of the three directions of the spatial rectangular coordinates system and use the speed information as motion information, specifically as the speed parameters (Vx2, Vy2, Vz2) and acceleration parameters (Ax2, Ay2, Az2); if the motion is turning over, the angular speed sensor and the angular acceleration sensor acquire a real-time angular speed and a real-time angular acceleration corresponding to each turnover moving in three directions of the spatial rectangular coordinates system and use the speed information as motion information after the turnover, specifically as the angular speed (Jx2, Jy2, Jz2) and angular acceleration (JAx2, JAy2, JAz2). Further, the speed and acceleration may be acquired through a calculation according to displacement after a mobile terminal change and the change time, for example, within a predetermined time range 0.1 s, the displacement distance in axis X may be acquired through X2-X1 and the speed can be acquired through a formula v=s/At, that is, a ratio of the displacement to the time cost for the displacement, and a real-time speed of another axis is also calculated by using this method. Likewise, the acceleration value may further be acquired according to the ratio of a speed variation to the time cost by the variation, that is, Δv/Δt. The angular speed and angular acceleration may further be acquired through a calculation according to an angle variation of the mobile terminal per unit time.

(2) Upon detection of completion of a motion change of the mobile terminal, spatial location information of the mobile terminal experiencing the motion change is acquired.

When the mobile terminal experiences physical motion, a sensor does not transmit spatial location coordinates and spatial angular coordinates in real time but transmits the current spatial location coordinates and spatial angular coordinates to the browser after the mobile terminal enters a relatively stationary state, and the browser uses the spatial location coordinates and spatial angular coordinates as the spatial location coordinates (X2, Y2, Z2) for a motion change and the spatial angular coordinates (Qx2, Qy2, Qz2) for a motion change after the location change. A process for judging whether the mobile terminal changes from a location change state to a relatively stationary state is the same as the process for judging whether the mobile terminal is in a relatively stationary state in step 201, which is not further described here. If the motion is location moving, the speed sensor and acceleration sensor respectively acquire an average speed and an average acceleration speed of the mobile terminal in each of the three directions of the spatial rectangular coordinates system and use the speed information as motion information, specifically as the speed parameters (Vx2, Vy2, Vz2) and acceleration parameters (Ax2, Ay2, Az2); if the motion is turning over, the angular speed sensor and the angular acceleration sensor acquire a real-time angular speed and a real-time angular acceleration corresponding to each turnover moving in three directions of the spatial rectangular coordinates system and use the speed information as motion information after the turnover, specifically as the angular speed (Jx2, Jy2, Jz2) and angular acceleration (JAx2, JAy2, JAz2). Further, the speed and acceleration may be acquired through a calculation according to displacement after a mobile terminal change and the change time, for example, within the time for the entire location moving, the displacement distance in axis X may be acquired through X2-X1 and the speed can be obtained through a formula v=s/At, that is, a ratio of the displacement to the time cost for the displacement, and a real-time speed of another axis is also calculated by using this method. Likewise, the acceleration value may further be acquired according to the ratio of a speed variation to the time cost by the variation, that is, Δv/Δt. The angular speed and angular acceleration may further be acquired through a calculation according to an angle variation of the mobile terminal per unit time.

Step 205: If motion information of the mobile terminal is greater than a predetermined threshold, comparing the spatial location information of the mobile terminal in the relatively stationary state with the spatial location information of the mobile terminal experiencing the motion change to acquire a spatial location offset after the motion change.

A predetermined setting is used for determining an acceleration threshold/an angular acceleration threshold that determines whether to perform a website operation due to the moving of the mobile terminal. Spatial location information and motion information for a motion change is acquired, after the mobile terminal experiences physical motion. An acceleration change/an angular acceleration change may be acquired irrespective of location moving and turnover motion, and therefore after the acceleration or angular acceleration in the acquired motion information is compared with the predetermined acceleration threshold/angular acceleration threshold that determines whether to perform an website operation, a subsequent process is implemented if the acceleration or angular acceleration in the acquired motion information is greater than the predetermined acceleration threshold/angular acceleration threshold, which indicates that the motion is for an website operation; otherwise, an operation is terminated.

A spatial location offset before and after the motion may be acquired by comparing the spatial location information in a relatively stationary state and the spatial location information after a motion change, and the spatial location offset includes at least a changed item and an unchanged item according to the comparison between spatial location coordinates in the relatively stationary state and the spatial location coordinates after the motion change, and further includes a changed item and an unchanged item according to the comparison between spatial angular coordinates in the relatively stationary state and the spatial angular coordinates after the motion change.

For example, after the acquired spatial location coordinates for a motion change and the spatial angular coordinates for a motion change are compared with the spatial location coordinates in a relatively stationary state and the spatial angular coordinates in a relatively stationary state according to two location information acquisition modes described in step 204, possible conditions are as follows:

(1) If results of comparisons between Y2, Z2, Qx2, Qy2, Qz2 and Y1, Z1, Qx1, Qy1, Qz1 change within the predetermined oscillation range while the change of X2 is beyond the predetermined oscillation range, the current motion is considered as displacement motion. At this time, if X1 is 2 and X2 is 10, X2 is greater than X1, and the current motion may be determined as a change along the positive direction of axis X (otherwise is determined as moving along the negative direction); according to the predetermined spatial location offset and a mapping relationship between webpage operations, the current motion of the mobile terminal is determined as moving to the right, and the difference between X2 and X1 is the displacement distance of the current motion. According to the mapping relationships with operations on a webpage, displacement motion of a mobile terminal upwards, downwards, to the left, and to the right correspond to moving a webpage, by a browser, upwards, downwards, to the left, and to the right.

After a motion direction is determined, whether the motion is acceleration motion or ordinary motion continues to be judged; since the motion change is along axis X, the judgment is performed according to Ax2 in the acquired acceleration parameters (Ax2, Ay2, Az2); if Ax2 is greater than the predetermined acceleration or uniform moving threshold, the current motion is considered as acceleration motion, and otherwise, the current motion is considered as uniform moving. If the current motion is considered as acceleration motion, the motion is converted to a webpage operation as rolling to the right; if the current motion is considered as uniform moving, the motion is converted to a webpage operation as sliding to the right. A moving rate and speed or an acceleration value of a webpage operation such as rolling or sliding after conversion is predetermined respectively.

The above description uses moving of a mobile terminal to the left as an example; if the mobile terminal moves towards upper right, that is, displacement occurs in both axes X and Y, two motion changes are calculated respectively; after positive and negative moving direction, displacement distance of the moving, and speed and acceleration in the moving directions are determined, operations are performed in two directions simultaneously after the motion is converted to actions on the webpage.

Possible conditions may further be:

(2) If results of comparisons between X2, Y2, Z2, Qx2, Qy2 and X1, Y1, Z1, Qx1, Qy1 change within the predetermined oscillation range while the change of Qz2 is beyond the predetermined oscillation range, the current motion is considered as rotation motion. A direction and an angle of the motion need to be firstly determined. If the difference between Qz1 and Qz2 is a positive number, the motion may be considered as a forward turnover; if the difference between Qz1 and Qz2 is a negative number, the motion may be considered as a backward turnover, and the difference is the angle of the turnover. If the motion is determined as a forward turnover, a conversion operation on the webpage is switching a webpage label to a previous label. If the motion is determined as a backward turnover, a converted operation on the webpage is switching a webpage label to a next label.

Further, angular acceleration during the turnover may also be judged; if the angular acceleration Az2 in axis Z during the turnover is greater than the predetermined threshold for determining acceleration or uniform turnover, the current motion is considered as acceleration turnover motion; otherwise, the current motion is considered as uniform turnover motion. Different webpage effects are achieved according to different motion states of the turnover. A webpage effect may be an accelerated switching effect or a uniform switching effect, and values of the turnover speed and angular speed or angular acceleration are predetermined respectively.

In a similar way, if the Qx2 change is determined beyond the predetermined oscillation range, the current motion is considered as a left and right turnover operation, and the left and right turnover operation is converted to a forward switching operation or a backward switching operation on a webpage, that is, switching the current webpage to a previous webpage or to a next webpage.

Possible conditions may further be: (3) If results of comparisons between Y2, Z2, Qx2, Qy2, Qz2 and Y1, Z1, Qx1, Qy1, Qz1 change within the predetermined oscillation range while the change of Z2 is beyond the predetermined oscillation range, the motion at that time is considered as displacement motion. At this time, if Z1 is 2 and Z2 is 10, Z2 is greater than X1, and the current motion may be determined as a change along the positive direction of axis Z (otherwise is determined as moving along the negative direction); according to a predetermined mapping relationship between the spatial location offset and webpage operations, the current motion of the mobile terminal is determined as moving forward (that is, the mobile terminal moves towards a user). The difference between Z2 and Z1 is the displacement distance of the current motion. An operation corresponding to the forward or backward displacement motion is zooming in or zooming out a webpage. If the current motion is considered as forward motion, the motion is converted to a webpage operation as zooming in a webpage; if the current motion is considered as backward moving, the motion converted to a webpage operation as zooming out a webpage.

Further, acceleration during the moving may be judged; if the moving acceleration Az2 in axis Z is greater than the predetermined threshold for judging acceleration or uniform webpage zooming in or out, the current motion is considered as acceleration motion; otherwise, the current motion is considered as uniform moving. Different zooming in or zooming out effects are achieved according to different motion states of the moving. A zooming in or zooming out effect may be accelerated zooming in/out or uniform zooming in/out, and values of the zooming in/out rate and speed or the acceleration are predetermined respectively.

After the user performs physical motion on the mobile terminal, generally, the mobile terminal is deviated from a normal range of visibility of the user, and therefore the mobile terminal needs to be moved to the original location to facilitate browsing. During a process for moving back to the original location, generally, an instant acceleration/angular acceleration is smaller and is smaller than an acceleration threshold/angular acceleration threshold that determines whether to perform a webpage operation, and therefore a webpage browse operation is not performed at this time.

Step 206: Performing a corresponding browse operation on a webpage on the mobile terminal according to a mapping relationship between the spatial location offset and a webpage operation.

A mapping relationship between a spatial location offset and a webpage operation is pre-stored in a browser and a corresponding browse operation is performed on a webpage. Specifically, location parameter value A for horizontal rolling, location parameter value B for vertical rolling, and current amplification coefficient parameter value α of the current webpage acquired initially are modified according to the spatial location offset, and therefore a corresponding browse operation is performed on the webpage. A mapping relationship between a spatial location offset and a webpage moving or zooming in and zooming out coefficient is predetermined, for example, if the mobile terminal moves 5 along axis X of the spatial location coordinates in the positive direction, the corresponding webpage browse operation is that A moves 10 pixel values along axis X in the positive direction; if the mobile terminal moves 5 along axis Z of the spatial location coordinates in the positive direction, the corresponding webpage browse operation is that a is zoomed out for 50%, that is, the webpage is zoomed out for 50%.

Specific operations are classified into two types:

(1) If the spatial location coordinates in the spatial location offset are changed while the spatial angular coordinates remain unchanged, corresponding browse operations such as accelerated or uniform webpage sliding, webpage rolling, webpage zooming in, and webpage zooming out are performed on the webpage on the mobile terminal.

(2) If the spatial angular coordinates in the spatial location offset are changed while the spatial location coordinates remain unchanged, corresponding browse operations such as accelerated or uniform webpage label switching forward and backward, webpage switching forward, and webpage switching backward are performed on the webpage on the mobile terminal.

Mapping relationships between spatial location offsets and webpage operations are as described in Table 1.

TABLE 1

| Change Item | Unchanged Item | Corresponding Webpage Browse Operation |
|---|---|---|
| Spatial | Spatial location | When the acceleration Ax2 is greater than |
| location | coordinates Y2 and Z2 | the predetermined threshold, according to the |
| coordinates | Spatial angular | determined moving direction, the webpage |
| X2 | coordinates Qx2, Qy2, | acceleratedly moves towards the positive or |
| | and Qz2 | negative direction along axis X. |
| | | When the acceleration Ax2 is smaller than |
| | | the predetermined threshold, according to the |
| | | determined moving direction, the webpage |
| | | uniformly moves towards the positive or |
| | | negative direction along axis X. |
| Spatial | Spatial location | When the acceleration Ay2 is greater than |
| location | coordinates X2 and Z2 | the predetermined threshold, according to the |
| coordinates | Spatial angular | determined moving direction, the webpage |
| Y2 | coordinates Qx2, Qy2, | acceleratedly moves towards the positive or |
| | and Qz2 | negative direction along axis Y. |
| | | When the acceleration Ay2 is smaller than |
| | | the predetermined threshold, according to the |
| | | determined moving direction, the webpage |
| | | uniformly moves towards the positive or |
| | | negative direction along axis Y. |
| Spatial | Spatial location | When the acceleration Az2 is greater than |
| location | coordinates X2 and Y2 | the predetermined threshold, according to the |
| coordinates | Spatial angular | determined moving direction, the webpage is |
| Z2 | coordinates Qx2, Qy2, | acceleratedly zoomed in or zoomed out. |
| | and Qz2 | When the acceleration Az2 is smaller than |
| | | the predetermined threshold, according to the |
| | | determined moving direction, the webpage is |
| | | zoomed in or zoomed out uniformly. |
| Spatial | Spatial location | When the angular acceleration JAz2 is |
| angular | coordinates X2, Y2, and | greater than the predetermined threshold, |
| coordinates | Z2 | according to the determined turnover direction, |
| Qz2 | Spatial angular | forward and backward labels of the webpage |
| | coordinates Qx2 and | are acceleratedly switched over. |
| | Qy2 | When the angular acceleration JAz2 is |
| | | smaller than the predetermined threshold, |
| | | according to the determined turnover direction, |
| | | forward and backward labels of the webpage |
| | | are uniformly switched over. |
| Spatial | Spatial location | When the angular acceleration JAz2 is |
| angular | coordinates X2, Y2, and | greater than the predetermined threshold, |
| coordinates | Z2 | according to the determined turnover direction, |
| Qx2 | Spatial angular | the webpage is acceleratedly switched over |
| | coordinates Qy2 and | forward or backward. |
| | Qz2 | When the angular acceleration JAz2 is |
| | | smaller than the predetermined threshold, |
| | | according to the determined turnover direction, |
| | | the webpage is uniformly switched over |
| | | forward or backward. |

A mapping relationship between a spatial location offset and a webpage operation may be a default factory setting of the mobile terminal browser, and the mapping relationship between a spatial location offset and a webpage operation may further be re-set according to a user behavior.

A user may change a parameter that is used for detecting motion according to a user operation behavior, for example, an acceleration threshold/angular acceleration threshold that determines whether to perform a webpage operation; or acceleration threshold/angular acceleration threshold that determines whether the motion is acceleration motion or uniform motion; or a parameter for each oscillation range that determines whether a state is a relatively stationary state; or a mapping relationship between a spatial location offset and a coefficient for webpage moving or zooming in and zooming out.

For two modes for obtaining the spatial location coordinates for a motion change and the spatial angular coordinates for a motion change mentioned in step 204, an effect of the first mode is that the browser performs, according to the mobile terminal motion, a corresponding operation on a webpage in real time; an effect of the second mode is that a browser performs a corresponding operation on a webpage after the motion of a mobile terminal ends.

Step 207: After the browser of the mobile terminal performs an operation on the webpage, using spatial location information for a motion change as an initial parameter, and acquiring the spatial location information for a motion change for a next motion upon detecting the next motion.

After a physical motion change of the mobile terminal is converted to a corresponding operation on a webpage, all kinds of current location parameters and angular parameters of the mobile terminal are used as parameters in the initial state, and a next physical motion change of the user is under detect. Therefore, the acquired spatial location coordinates for a motion change and spatial angular coordinates for a motion change are set as the parameters in the initial state, and spatial location information for a motion change for a next motion is acquired upon detecting the next motion.

It should be noted that a conversion according to physical motion of a mobile terminal to a corresponding operation performed by a browser on a webpage may be enabled or disabled according to a user requirement, such that unnecessary misoperations at certain time may be avoided, and this function may co-exist with an operation mode in the prior art so that an existing webpage browse mode may be used to perform a browse operation.

In the embodiments of the present disclosure, spatial location information of a mobile terminal experiencing a motion change and the spatial location information of the mobile terminal in a relatively stationary state acquired by a sensor are compared to acquire a spatial location offset after the motion change, and a corresponding browse operation is performed on a webpage on the mobile terminal according to a mapping relationship between the spatial location offset and a webpage operation. By getting rid of relying on physical keys for webpage browsing on a mobile terminal, occurrence of misoperations is reduced, and user experience is improved.

### Embodiment 3

An embodiment of the present disclosure provides a webpage browsing apparatus based on physical motion. The apparatus, whose structure is as illustrated in FIG. 3, includes a first acquiring module 301, a second acquiring module 302, a comparing module 303, and a processing module 304.

The first acquiring module 301 is configured to acquire spatial location information of a mobile terminal in a relatively stationary state;

The first acquiring module 301 is specifically configured to:

acquire the spatial location information of the mobile terminal in the relatively stationary state according to a parameter acquired by at least one of a gravity sensor, an acceleration sensor, an orientation sensor, a speed sensor, an angular speed sensor, and an angular acceleration sensor, and a spatial rectangular coordinates system built in the sensor.

The second acquiring module 302 is configured to: upon detecting a motion change of the mobile terminal, acquire spatial location information and motion information of the mobile terminal experiencing the motion change.

The second acquiring module 302 is specifically configured to:

acquire the spatial location information and the motion information of the mobile terminal experiencing the motion change according to a parameter acquired by at least one of a gravity sensor, an acceleration sensor, an orientation sensor, a speed sensor, an angular speed sensor, and an angular acceleration sensor, and a spatial rectangular coordinates system built in the sensor.

The second acquiring module 302 specifically includes:

The first acquiring unit 3021 is configured to: upon detecting a motion change of the mobile terminal, acquire spatial location information and motion information of the mobile terminal experiencing the motion change;

and/or

a second acquiring unit 3022, configured to: upon detecting completion of a motion change of the mobile terminal, acquire spatial location information and motion information of the mobile terminal experiencing the motion change.

The comparing module 303 is configured to: if motion information of the mobile terminal is greater than a predetermined threshold, compare the spatial location information of the mobile terminal in the relatively stationary state with the spatial location information of the mobile terminal experiencing the motion change to acquire a spatial location offset after the motion change; and

The processing module 304 is configured to perform a corresponding browse operation on a webpage on the mobile terminal according to a mapping relationship between the spatial location offset and a webpage operation.

The processing module 304 includes:

a first processing unit 3041, configured to: if the spatial location coordinates in the spatial location offset are changed while the spatial angular coordinates remain unchanged, perform corresponding browse operations such as accelerated or uniform webpage sliding, webpage rolling, webpage zooming in, and webpage zooming out on the webpage on the mobile terminal;

a second processing unit 3042, configured to: if the spatial angular coordinates in the spatial location offset are changed while the spatial location coordinates remain unchanged, perform corresponding browse operations such as accelerated or uniform webpage label switching forward and backward, webpage switching forward, and webpage switching backward on the webpage on the mobile terminal.

The apparatus further includes:

a setting module 305, configured to set the mapping relationship between the spatial location offset and the webpage operation according to user settings.

The spatial location information includes:

spatial location coordinates; or

spatial angular coordinates; or

spatial location coordinates and spatial angular coordinates.

The motion information includes:

acceleration and speed; or

angular acceleration and angular speed; or

acceleration, speed, angular acceleration, and angular speed.

In the embodiments of the present disclosure, spatial location information of a mobile terminal experiencing a motion change and the spatial location information of the mobile terminal in a relatively stationary state acquired by a sensor are compared to acquire a spatial location offset after the motion change, and a corresponding browse operation is performed on a webpage on the mobile terminal according to a mapping relationship between the spatial location offset and a webpage operation. By getting rid of relying on physical keys for webpage browsing on a mobile terminal, occurrence of misoperations is reduced, and user experience is improved.

A person skilled in the art should understand that all or part of steps of the preceding methods may be implemented by hardware or hardware following instructions of programs. The programs may be stored in a non-transitory computer-readable storage medium and may be executed by at least one processor. The storage medium may be a read-only memory, a magnetic disk, or a compact disc-read only memory.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

1. A webpage browsing method based on physical motion, comprising:
acquiring spatial location information of a mobile terminal in a relatively stationary state;
upon detecting a motion change of the mobile terminal, acquiring spatial location information and motion information of the mobile terminal experiencing the motion change;
if motion information of the mobile terminal is greater than a predetermined threshold, comparing the spatial location information of the mobile terminal in the relatively stationary state with the spatial location information of the mobile terminal experiencing the motion change to acquire a spatial location offset after the motion change; and
performing a corresponding browse operation on a webpage on the mobile terminal according to a mapping relationship between the spatial location offset and a webpage operation, the corresponding browse operation further comprising:
if the spatial location coordinates in the spatial location offset are changed while the spatial angular coordinates remain unchanged, performing corresponding browse operations such as accelerated or uniform webpage sliding, webpage rolling, webpage zooming in, and webpage zooming out on the webpage on the mobile terminal; and
if the spatial angular coordinates in the spatial location offset are changed while the spatial location coordinates remain unchanged, performing corresponding browse operations such as accelerated or uniform webpage label switching forward and backward, webpage switching forward, and webpage switching backward on the webpage on the mobile terminal.

2. The method according to claim 1, wherein the acquiring spatial location information of a mobile terminal in a relatively stationary state comprises:

3. The method according to claim 1, wherein the acquiring spatial location information and motion information of the mobile terminal experiencing the motion change comprises:
acquiring the spatial location information and the motion information of the mobile terminal experiencing the motion change according to a parameter acquired by at least one of a gravity sensor, an acceleration sensor, an orientation sensor, a speed sensor, an angular speed sensor, and an angular acceleration sensor, and a spatial rectangular coordinates system built in the sensor.

4. The method according to claim 1, wherein upon detecting a motion change of the mobile terminal, acquiring spatial location information and motion information of the mobile terminal experiencing the motion change comprises:
upon detecting a motion change of the mobile terminal, acquiring spatial location information and motion information of the mobile terminal experiencing the motion change at each predetermined time interval;
or,
upon detecting completion of a motion change of the mobile terminal, acquiring spatial location information and motion information of the mobile terminal experiencing the motion change.

5. (canceled)

6. The method according to claim 1, further comprising:
setting the mapping relationship between the spatial location offset and the webpage operation according to user settings.

7. The method according claim 1, wherein the spatial location information comprises:
spatial location coordinates; or
spatial angular coordinates; or
spatial location coordinates and spatial angular coordinates.

8. The method according to claim 1, wherein the motion information comprises:
acceleration and speed; or
angular acceleration and angular speed; or
acceleration, speed, angular acceleration, and angular speed.

9. A webpage browsing apparatus based on physical motion, comprising:
a first acquiring module, configured to acquire spatial location information of a mobile terminal in a relatively stationary state;
a second acquiring module, configured to: upon detecting a motion change of the mobile terminal, acquire spatial location information and motion information of the mobile terminal experiencing the motion change;
a comparing module, configured to: if motion information of the mobile terminal is greater than a predetermined threshold, compare the spatial location information of the mobile terminal in the relatively stationary state with the spatial location information of the mobile terminal experiencing the motion change to acquire a spatial location offset after the motion change; and
a processing module, configured to perform a corresponding browse operation on a webpage on the mobile terminal according to a mapping relationship between the spatial location offset and a webpage operation, the processing module comprising:
a first processing unit, configured to: if the spatial location coordinates in the spatial location offset are changed while the spatial angular coordinates remain unchanged perform corresponding browse operations such as accelerated or uniform webpage webpage rolling, webpage zooming in, and webpage zooming out on the webpage on the mobile terminal; and
a second processing unit, configured to: if the spatial angular coordinates in the spatial location offset are changed while the spatial location coordinates remain unchanged, perform corresponding browse operations such as accelerated or uniform webpage label switching forward and backward webpage switching forward, and webpage switching backward on the webpage on the mobile terminal.

10. The apparatus according to claim 9, wherein the first acquiring module is specifically configured to:
acquire the spatial location information of the mobile terminal in the relatively stationary state according to a parameter acquired by at least one of a gravity sensor, an acceleration sensor, an orientation sensor, a speed sensor, an angular speed sensor, and an angular acceleration sensor, and a spatial rectangular coordinates system built in the sensor.

11. The apparatus according to claim 9, wherein the second acquiring module is specifically configured to:
acquire the spatial location information and the motion information of the mobile terminal experiencing the motion change according to a parameter acquired by at least one of a gravity sensor, an acceleration sensor, an orientation sensor, a speed sensor, an angular speed sensor, and an angular acceleration sensor, and a spatial rectangular coordinates system built in the sensor.

12. The apparatus according to claim 9, wherein the second acquiring module comprises:
a first acquiring unit, configured to: upon detecting a motion change of the mobile terminal, acquire spatial location information and motion information of the mobile terminal experiencing the motion change at each predetermined time interval;
and/or
a second acquiring unit, configured to: upon detecting completion of a motion change of the mobile terminal, acquire spatial location information and motion information of the mobile terminal experiencing the motion change.

13. (canceled)

14. The apparatus according to claim 9, further comprising:
a setting module, configured to set the mapping relationship between the spatial location offset and the webpage operation according to user settings.

15. The apparatus according to claim 9, wherein the spatial location information comprises:
spatial location coordinates; or
spatial angular coordinates; or
spatial location coordinates and spatial angular coordinates.

16. The apparatus according to claim 9, wherein the motion information comprises:
acceleration and speed; or
angular acceleration and angular speed; or
acceleration, speed, angular acceleration, and angular speed.
